(19) United States
(12) Patent Application Publication
(10) Pub. No.: US 2004/0049323 A1
(43) Pub. Date: Mar. 11, 2004

(54) Haptic seat notification system

(75) Inventors: Louis Tijerina, Dearborn, MI (US); Thomas Edward Pilutti, Ann Arbor, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI (US)

(21) Appl. No.: 10/064,979

(22) Filed: Sep. 5, 2002

(51) Int. Cl. G06F 17/00

(52) U.S. Cl. 701/1

(57) ABSTRACT

A haptic seat notification system includes a plurality of motors located in a driver's seat and operative to provide a directional stimulus to a driver. A forward detection apparatus is used to detect vehicle lane departure and a vehicle speed sensor is used to detect vehicle overspeed conditions. When the vehicle crosses a lane edge, the system provides a lane departure stimulus to the driver. When the vehicle is overspeed, the system provides an overspeed stimulus to the driver. When the vehicle crosses a lane edge while being overspeed, the system provides a curve overspeed stimulus to the driver.

### BACKGROUND OF INVENTION

1. Technical Field

The present invention relates generally to warning systems for automotive vehicles, and more particularly, to a haptic seat notification system.

2. Background Art

An analysis conducted on road departure crash statistics from the USDOT General Estimates System has provided evidence that an effective road departure warning countermeasure would comprise two components: (1) warning based on drifting off the road, and (2) warning based on excessive speed in a curve. Vision-based systems have demonstrated capability in road drift scenarios, and curve overspeed solutions are being investigated through the use of GPS and map databases.

Vision-based road departure warning (RDW) systems are currently in the process of making the transition from research projects to early production implementations. These systems detect road attributes such as lane marks to determine the relative lateral position of the vehicle in the lane. The relative lateral position is tracked over time, and a warning is given if the vehicle crosses a lane marking. A decision making algorithm such as time-to-lane-cross, in conjunction with other heuristics, are used to make the timing of the warning both useful to the driver as well as to reduce the occurrence of false warnings.

GPS/Map-based RDW is currently under development to address the curve overspeed warning part of the problem. Computer vision is not well suited for the far look-ahead requirements of curve overspeed, while GPS positioning in conjunction with a map database from which to extract road curvature has shown promise in early development.

A common warning device for vision-based RDW systems has been to use a beep or buzzer to alert the driver. More recently, pre-recorded or simulated rumble strip sounds played through the left or right vehicle audio system channels have been used, and are perceived more positively than beeps and buzzes. The audio rumble strip is an intuitive approach, but it does have certain implementation issues. One issue is that the warning is presented not only to the driver, but to the passengers as well. A second issue is that while rumble strips are intuitive for drifting out of lane, curve overspeed warning is not so intuitively accomplished with rumble strips.

The disadvantages associated with these conventional notification techniques has made it apparent that a new technique is needed. The new technique should provide adequate notification while enhancing driver performance. The present invention is directed to these ends.

### SUMMARY OF INVENTION

It is, therefore, an object of the invention to provide an improved and reliable haptic seat notification system.

In accordance with the objects of this invention, a haptic seat notification system is provided. The haptic seat notification system includes a plurality of motors located in a driver's seat and operative to provide a directional stimulus to a driver. A forward detection apparatus is used to detect vehicle lane departure and a vehicle speed sensor is used to detect vehicle overspeed conditions. When the vehicle crosses a lane edge, the system provides a lane departure stimulus to the driver. When the vehicle is overspeed, the system provides an overspeed stimulus to the driver. When the vehicle crosses a lane edge while being overspeed, the system provides a curve overspeed stimulus to the driver.

The present invention thus achieves an improved haptic seat notification system. The present invention is advantageous in that it enhances driver braking performance.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF DRAWINGS

In order that the invention may be well understood, there will now be described some embodiments thereof, given by way of example, reference being made to the accompanying drawings, in which:

FIG. 1 illustrates a haptic seat system in accordance with one embodiment of the present invention;

FIG. 2 is a haptic seat notification apparatus in accordance with one embodiment of the present invention;

FIG. 3 illustrates a haptic seat in accordance with one embodiment of the present invention;

FIGS. 4-6 illustrate various notification patterns used by a haptic seat system in accordance with one embodiment of the present invention.

### DETAILED DESCRIPTION

In the following figures, the same reference numerals will be used to identify identical components in the various views. The present invention is illustrated with respect to a haptic seat notification system, particularly suited for the automotive field. However, the present invention is applicable to various other uses that may require a haptic seat notification system.

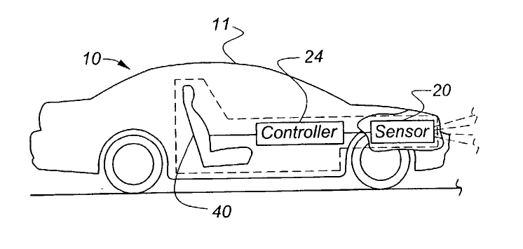

Referring to FIG. 1, a haptic seat notification system 10 according to one embodiment of the present invention will be described. Vehicle 11 includes a haptic seat notification apparatus 23 having a driver's seat 40 coupled to a controller 24 receiving signals from a forward detection apparatus 20. The forward detection apparatus 20 detects the lane position of driving vehicle 10 by irradiating laser beams, infrared, radar, microwave or equivalent detection means.

The intention of the present invention is to provide a warning to the driver to pay attention to an upcoming road condition, such as a curve, intersection configuration, or lane departure. By using a haptic seat 40 with small vibrating mechanisms, the present invention provides a solution to the problem of how to warn a driver with a modality that most closely matches already understood driving cues.

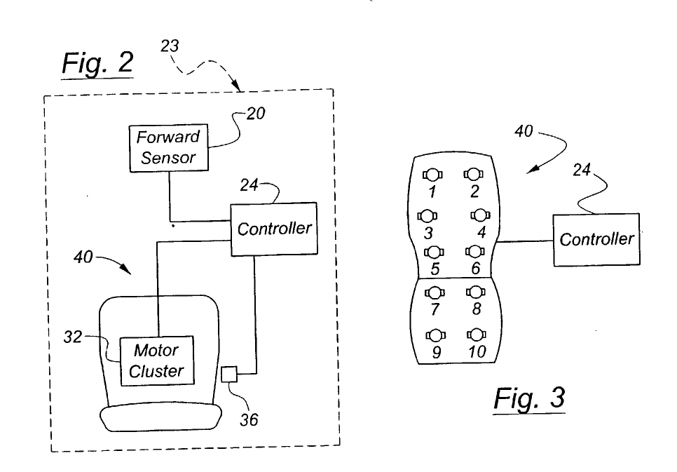

Referring to FIG. 2, a haptic seat notification apparatus 23 according to one embodiment of the present invention will be described. The forward detection apparatus 20 detects a relative lane position and speed of the vehicle and signals controller 24. Controller 24 notifies the driver to pay attention to an upcoming road condition, such as a curve, intersection configuration, or lane depart. In the preferred embodiment, the notification is a physical signal transmitted to the driver through seat 40 by using a plurality of small vibrating mechanisms 32. The level of notification given to the driver is may be proportional to the speed and ‘out of lane’ position of the vehicle.

In the preferred embodiment, the level of notification is a continuous function of relative speed, relative lane position, and lane condition. For minor lane departures the physical signal would have a low intensity and frequency. For major lane departures the physical signal would have an increased intensity level and frequency.

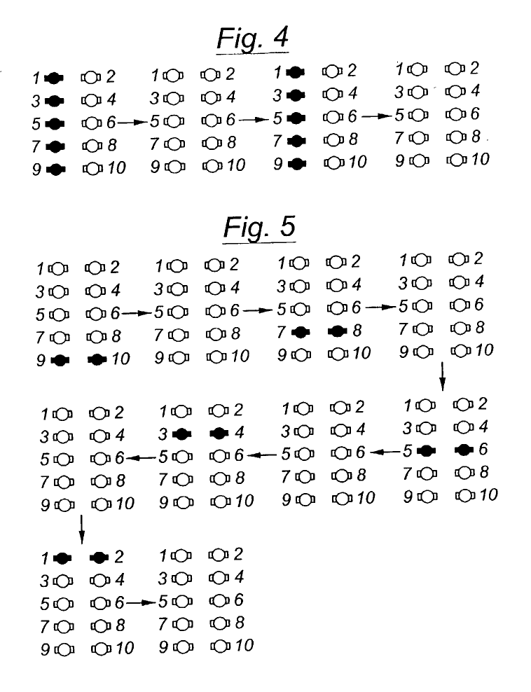

Referring to FIG. 3, a haptic seat apparatus 40 is illustrated. The apparatus includes a seat cushion with five motor pairs 1-10, a motor controller 24 to take command signals and power the motors, and a pattern generator to create command signals for a curve overspeed alert as well as a road departure alert.

The seat cushion comprises five DC motor pairs 1-10. The motors are eccentrically loaded with shaft masses that cause vibrations at the operating frequency. The motor pairs are spaced symmetrically along the vertical seat axis. The motors operate within the voltage range of 10 to 13.8 VDC using Low/Med/High speed settings.

The vibrating seat motors 1-10 are controlled using externally supplied commands that determine the operating speed and duty cycle (pulse-width modulation PWM) for each motor in the seat. The motors operate at three speed settings designated as Low, Medium and High. Motor speed settings may be adjusted by the driver for comfort or detectability. The controller 24 also makes motor speed an option for haptic display design.

The seat control module 24 provides individual control with respect to motor speed, and permits significant flexibility in the implementation of operational patterns for road departure and curve overspeed alerts.

The approach to road drift with the haptic seat is to provide a directional stimulus based on the output of the computer vision-based lane detection system. The seat can pulse the left side motors for a left lane departure, and vice versa for a right lane departure.

The lane detection system is capable of detecting the extent to which the vehicle has crossed the lane edge, and permits the warning to be a function of how far the vehicle has traversed the lane edge. Most lane detection systems can distinguish between solid and dashed lines, thereby reducing false alarms generated by crossing dashed lines with using a turn indicator. The warning can also be a function of the cumulative excursion time.

The curve overspeed alert does not have a direct analogy on the road as does the rumble strip alert. There are warning signs to alert the driver of the recommended speed for a curve or road section, but there are no curve overspeed warnings that have a direct recognition opportunity. One possible approach to curve overspeed warning is to extract speed limit sign information from a digital map database, and then provide a “bong” auditory alert when the current speed exceeds the proper speed for the curve, or to modify the speedometer to show the “advised” speed. These approaches, while possible, create potential conflict in the drivers' recognition of a potential road departure event.

With rumble strip alerts being displayed through the seat, an approach to provide overspeed warning via the seat is also provided. A seat-based solution presented itself by exploring other forms of road-based warnings. That solution came by taking a cue from rumble bars placed prior to tollbooths or at the end of a long freeway segment as it transitions to two-way traffic. These rumble strips are similar to road departure rumble strips built into the road shoulder, but go across the whole road width, engaging tires on both sides of the vehicle.

The proposed curve overspeed alert emulates the rumble bars by pulsing the seat motors in a “wave” pattern up the seat, and repeating as needed. Motor pairs on both sides of the seat are operated together as the pattern progresses up the seat. Pattern details are provided in Section 3.3.

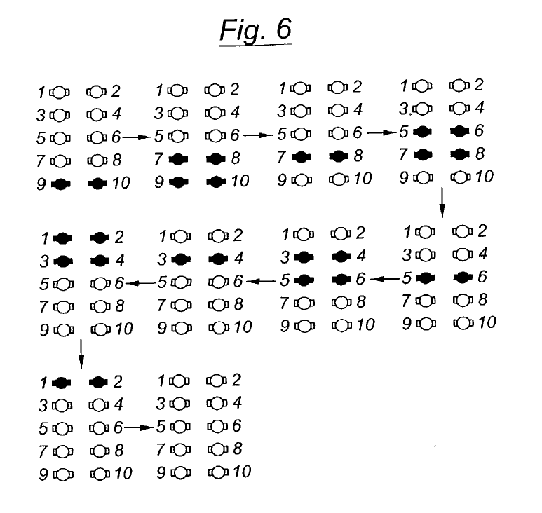

Referring to FIGS. 4-6, various notification patterns used by a haptic seat system in accordance with one embodiment of the present invention are illustrated. The rumble strip pattern for a right road departure alert is shown in FIG. 4. Please note that the motor pattern shown is facing the seat, and is based on the motor numbers and layout as shown in FIG. 3. Therefore, the odd numbered motors are along the driver's right side. Solid filled motor icons are ON.

The pattern can repeat as necessary, and the time duration between repeated patterns is separately controlled.

Not shown is the ability to control the rotational speed of the motor spindle. As described in previously, low, medium, or high speed settings are available. Typically, a single speed setting is used, and involves a scalar multiplier from the seat controller 24.

FIGS. 5-6 show the wave pattern in two variations. The first variation is a non-overlapping type described using FIG. 5. An overlapping wave pattern, where two pairs of motors are operating at the same time, is described in FIG. 6.

Using the motor layout of FIG. 3, FIG. 5 shows the non-overlapping wave pattern. Starting at the front of the seat under the legs, motor pair M9-10 pulses, stops, and then pair M7-8 pulse and stop, continuing up to motor pair M1-2 at the shoulders. The pattern concludes with all motors off.

The time that the motor pairs are on is controlled separately compared to the time that the motor pairs are in the off period.

The overlapping wave pattern is an extension of the non-overlapping pattern where two motor pairs are on at the same time. The overlapping effect was found to increase the continuity of the wave effect to the person sitting in the seat. The overlapping pattern is shown in FIG. 6.

There are the same number of steps to complete a full cycle of the overlapping pattern as compared to the non-overlapping pattern, however, there is only one period (at the cycle end) where all motors are off.

From the foregoing, it can be seen that there has been brought to the art a new and improved haptic seat notification system. It is to be understood that the preceding description of the preferred embodiment is merely illustrative of some of the many specific embodiments that represent applications of the principles of the present invention. Clearly, numerous and other arrangements would be evident to those skilled in the art without departing from the scope of the invention as defined by the following claims:

1. A haptic notification apparatus comprising:
a driver seat;
a plurality of motors located in said seat and operative to produce a haptic signal in said seat;
a forward detection apparatus operative to detect vehicle position relative to a lane and generate a lane signal proportional to said vehicle position in said lane; and
a controller coupled to said plurality of motors and being operative to receive said lane signal, said controller including control logic operative to control said plurality of motors to generate at least one distinctive pattern of motor activation based upon said lane signal, said distinctive pattern providing haptic notification of lane position to a driver.

2. The haptic notification apparatus as recited in claim 1, wherein said plurality of motors are operative to generate said haptic signal with a variable intensity.

3. The haptic notification apparatus as recited in claim 1, wherein said plurality of motors are operative to generate said haptic signal with a high, medium, and low intensity.

4. The haptic notification apparatus as recited in claim 1, wherein said plurality of motors are operative to generate said haptic signal with a variable frequency.

5. The haptic notification apparatus as recited in claim 1, wherein said plurality of motors are operative to generate said haptic signal with a high, medium, and low frequency.

6. The haptic notification apparatus as recited in claim 1, wherein said controller includes control logic operative to generate a lane departure pattern for a lane departure.

7. The haptic notification apparatus as recited in claim 1, wherein said controller includes control logic operative to generate a right lane departure pattern on a right side of said seat for a right lane departure.

8. The haptic notification apparatus as recited in claim 1, wherein said controller includes control logic operative to generate a left lane departure pattern on a left side of said seat for a left lane departure.

9. A haptic notification apparatus comprising:
a driver seat;
a plurality of motors located in said seat and operative to produce a haptic signal in said seat;
a speed detection apparatus operative to detect vehicle speed and generate an overspeed signal proportional said vehicle over a predetermined vehicle speed; and
a controller coupled to said plurality of motors and being operative to receive said overspeed signal, said controller including control logic operative to control said plurality of motors to generate at least one distinctive pattern of motor activation based upon said overspeed signal, said distinctive pattern providing haptic notification of overspeed to a driver.

10. The haptic notification apparatus as recited in claim 9, wherein said plurality of motors are operative to generate said haptic signal with a variable intensity.

11. The haptic notification apparatus as recited in claim 9, wherein said plurality of motors are operative to generate said haptic signal with a high, medium, and low intensity.

12. The haptic notification apparatus as recited in claim 9, wherein said plurality of motors are operative to generate said haptic signal with a variable frequency.

13. The haptic notification apparatus as recited in claim 9, wherein said plurality of motors are operative to generate said haptic signal with a high, medium, and low frequency.

14. The haptic notification apparatus as recited in claim 9, wherein said controller includes control logic operative to generate a rumble strip pattern when said vehicle is overspeed.

15. The haptic notification apparatus as recited in claim 1, further comprising a forward detection apparatus operative to detect vehicle position relative to a lane edge and generate a lane edge signal proportional said vehicle position over said lane edge.

16. The haptic notification system as recited in claim 15, wherein said controller includes control logic operative to generate a curve overspeed pattern for a lane departure when said vehicle is overspeed.

17. The haptic notification apparatus as recited in claim 15, wherein said controller includes control logic operative to generate a right curve overspeed pattern a right lane departure when said vehicle is overspeed.

18. The haptic notification apparatus as recited in claim 15, wherein said controller includes control logic operative to generate a left curve overspeed pattern for a left lane departure when said vehicle is overspeed.
